(19) United States
(12) Patent Application Publication
(10) Pub. No.: US 2023/0306635 A1
(43) Pub. Date: Sep. 28, 2023

(54) INFORMATION SUPERIMPOSITION DEVICE, INFORMATION SUPERIMPOSITION METHOD, AND PROGRAM

(71) Applicant: NTT Communications Corporation, Tokyo (JP)

(72) Inventor: Shuhei TARASHIMA, Yokohama-shi (JP)

(21) Appl. No.: 18/325,349

(22) Filed: May 30, 2023

Related U.S. Application Data
(63) Continuation of application No. PCT/JP2021/045401, filed on Dec. 9, 2021.

(30) Foreign Application Priority Data
Dec. 11, 2020 (JP) 2020-206298

(51) Int. Cl. G06T 7/73; G06V 20/40

(52) U.S. Cl. CPC G06T 7/74; G06V 20/46

(57) ABSTRACT

In accordance with present invention, an information superimposition device for superimposing, in a video, superimposition information that is associated with an object in the video, includes: a memory; and a processor coupled to the memory and configured to: extract candidate superimposition positions from the video, based on positions of one or more objects recognized in the video, the candidate superimposition positions being positions where the superimposition information can be superimposed without overlapping the one or more objects recognized in the video; and determine a position of the superimposition information, based on a set of the candidate superimposition positions and the positions of the one or more objects recognized in the video, such that a distance between the object and the superimposition information that is associated with the object is made small.

### CROSS-REFERENCE TO RELATED APPLICATION

The present application is a continuation filed under 35 U.S.C. 111(a) claiming the benefit under 35 U.S.C. 120 and 365(c) of PCT International Application No. PCT/JP2021/045401, filed on Dec. 9, 2021, and designating the U.S., which is based on and claims priority to Japanese Patent Application No. 2020-206298, filed on Dec. 11, 2020. The entire contents of PCT International Application No. PCT/JP2021/045401 and Japanese Patent Application No. 2020-206298 are incorporated herein by reference.

### BACKGROUND OF THE INVENTION

### 1. Field of the Invention

The present invention relates to a technique of recognizing an object in a video and superimposing related information with respect to the recognized object.

### 2. Description of the Related Art

Conventionally, there is a technique of recognizing an object in a video and superimposing related information with respect to the recognized object. By superimposing and displaying information related to a specific object shown in a video, the viewer can obtain the information without actively searching for it.

The process of recognizing a specific object in an input video and superimposing and displaying its related information in the video can be broadly divided into two processes: the process of recognizing the specific object (object recognition process); and the process of using the result of the recognition process as input and superimposing information (information superimposition process).

### CITATION LIST

### Patent Literature

[Patent Literature 1] Unexamined Japanese Patent Application Publication No. 2009-251774

### SUMMARY OF THE INVENTION

### Technical Problem

In relationship to the information superimposition process described above, there is a conventional technique of displaying related information at a position in contact with the region of an object detected from a video. However, with this conventional technique, the related information often hides the object itself or nearby objects, which then damages the quality of the viewing experience. That is, the problem with this conventional information superimposition process is that related information cannot be displayed such that the viewer can easily understand the content of the related information.

The present invention has been made in view of the above, and aims to provide a technique, whereby related information that is associated with an object can be superimposed over a video such that the viewer can easily understand the content of the related information.

### Solution to Problem

According to the technique of the present disclosure, an information superimposition device for superimposing, in a video, superimposition information that is associated with an object in the video, includes:
a memory; and
a processor coupled to the memory and configured to:
   extract candidate superimposition positions from the video, based on positions of one or more objects recognized in the video, the candidate superimposition positions being positions where the superimposition information can be superimposed without overlapping the one or more objects recognized in the video; and
   determine a position of the superimposition information, based on a set of the candidate superimposition positions and the positions of the one or more objects recognized in the video, such that the superimposition information that is associated with the object is placed in a vicinity of the object.

### Advantageous Effects of the Invention

According to the disclosed technique, a technique whereby related information that is associated with an object in a video can be superimposed over the video such that the viewer can easily understand the content of the related information is provided.

### BRIEF DESCRIPTION OF THE DRAWINGS

FIG. 1 is a diagram that shows an example of superimposing and displaying information that relates to a specific object in a video;

FIG. 2 is a diagram that shows an example of a case in which identification of a class or an attribute fails;

FIG. 3 is a diagram that shows an example of a case in which identification of a class or an attribute fails;

FIG. 4 is a structure diagram of an information indicating device;

FIG. 5 is a diagram for explaining the operation of the information indicating device;

FIG. 6 is a diagram that shows examples of information to be superimposed;

FIG. 7 is a structure diagram of an object recognition device;

FIG. 8 is a structure diagram of a label identifying part;

FIG. 9 is a diagram for explaining the operation of the object recognition device;

FIG. 10 is a diagram that shows an example of an object;

FIG. 11 is a diagram for explaining a method of extracting an object that is located in front of another object;

FIG. 12 is a diagram for explaining a method of determining whether or not an attribute of an object is visible enough to be recognized;

FIG. 13 is a structure diagram of an information superimposition device;

FIG. 14 is a diagram for explaining the operation of the information superimposition device;

FIG. 15 is a diagram for explaining candidate object superimposition positions; and

FIG. 16 is a diagram that shows an example hardware structure of devices.

### DETAILED DESCRIPTION OF THE PREFERRED EMBODIMENTS

Hereinafter, embodiments of the present invention will be described with reference to the accompanying drawings. The embodiments described below are simply examples, and embodiments to which the present invention is applicable are by no means limited to the following embodiments.

### Summary of Embodiments

The herein-contained embodiments relate to a technique for recognizing a specific object shown in an input video, and superimposing and displaying its related information in the video.

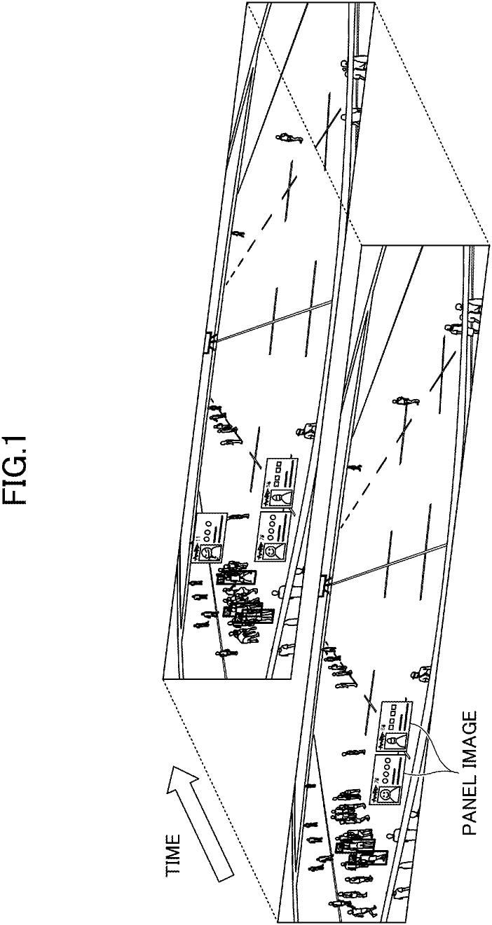

To illustrate a specific example of this technique, FIG. 1 shows an example, in which, using video of a rugby match as input, the players in the video are identified, and their related information such as their names, positions, heights, and weights are displayed as panel images near the players.

In this way, if it is possible to superimpose and display information related to a specific object (for example, a player) in a video, the viewer can obtain the information without having to actively search for it. In particular, if the viewer is not knowledgeable about the target video, even if the viewer is interested in an object shown in the video, there are few means to search for the details of the object, and therefore displaying information in a superimposing fashion is expected to improve the viewer’s understanding of the video’s content significantly. That is, the technique according to the present embodiment leads to an improved viewing experience.

To recognize a specific object in an input video and superimpose its related information in the video, roughly two processes are needed: namely, the process of recognizing a specific object (object recognition process); and the process of superimposing information by using the result of recognition as input.

With the herein-contained embodiments, an example related to the object recognition process will be described as an embodiment 1, and an example related to the information superimposition process will be described as an embodiment 2. Note that, although embodiments will be described below in which the object recognition process and the information superimposition process are combined, the object recognition process and the information superimposition process may be carried out independently.

Before describing the device structure and operation according to each embodiment, first, the details of the problem will be described. Note that the details of the cited references that will be touched upon in the following description are listed at the end of this specification.

### Issues Related to Embodiment 1

One of the simplest ways to implement the object recognition process is to detect objects of interest from each image frame in a video by using the object detector disclosed in cited reference 1, for example. In this case, it is necessary to prepare training data for training the object detector, for each target object. Collecting training data like this generally entails a non-negligible cost. In particular, when different target objects look alike, such as, for example, when a number of players wear the same uniform as in the example shown in FIG. 1, an enormous amount of training data needs to be prepared to distinguish between them, and, if the data is insufficient, the accuracy of recognition becomes poor.

In another method, it is possible to detect candidate objects, and then recognize a specific object by detecting a predetermined class or attribute from each candidate object. To be more specific, with the example of FIG. 1, a method of first detecting individuals from the image frame, inferring the team (a specific example of a class) from their overall appearance, and identifying the uniform numbers (a specific example of an attribute) by using the method disclosed in cited reference 2, thereby uniquely identifying the players from the combination of the team and the uniform numbers, may be used. Using this method eliminates the need for preparing training data for each target object.

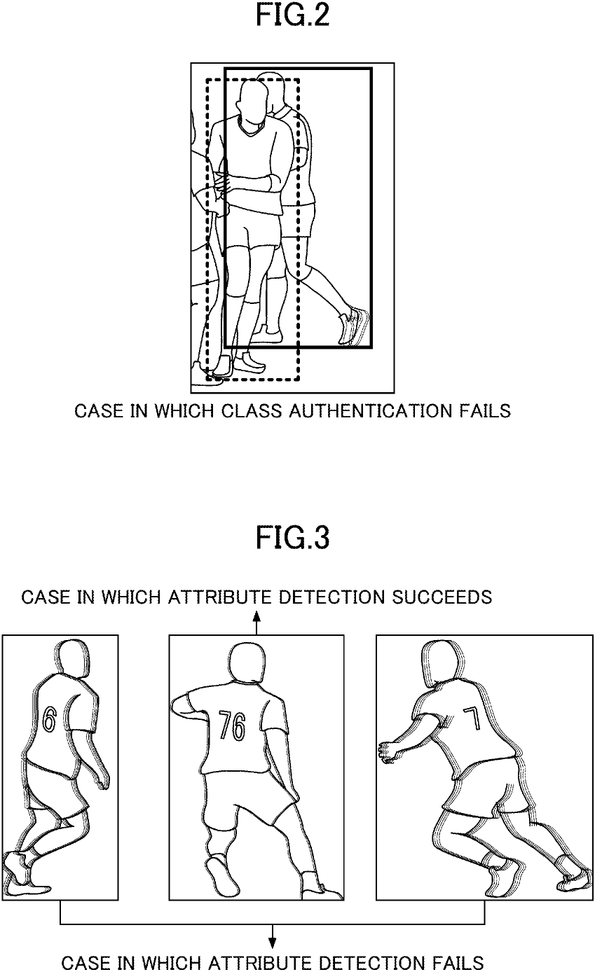

However, this method has two major problems. The first problem is that, depending on the positional relationship between the object and the camera, the image frame may not contain enough visible information to recognize/determine its class or attribute, and the recognition often fails. Examples are shown in FIG. 2 and FIG. 3. In the example of FIG. 2, the player surrounded by the solid-line frame is mostly hidden by the player surrounded by the dotted-line frame, and, when the solid-line frame is used as an indication for the appearance, there is a possibility that the inference of the team will fail.

Also, in the example of FIG. 3, the player’s uniform number is printed as 76 on the back, and, although the uniform number can be recognized distinctly in the center image, only a portion of it is shown in the images on the sides (only “6” is shown in the left image, and only “7” is shown in the right image), and it is therefore extremely difficult to recognize the correct uniform number from these images.

The second problem is that recognizing and detecting a class and an attribute for all the detection results entails a high cost of calculation. This problem becomes more pronounced in cases in which a large number of target objects are captured, or in cases in which real-time processing is required.

As described above, when the technique of detecting a class and an attribute of candidate objects and identifying a specific object is simply employed, the accuracy of recognition of the class and attribute to serve as indications that identify the specific object is low, and there is also a problem that the processing speed is slow.

### Issues Related to Embodiment 2

Next, regarding the information superimposition process, cited reference 3 discloses a method of outputting and displaying a label at a position in contact with a detected object’s field. When the method of cited reference 3 is used to display superimposition information of a size equal to or larger than a target object, like the panels shown in the example of FIG. 1, the panel often hides the object itself or nearby objects, and damages the quality of the viewing experience.

In order to solve the above problem, that is, in order not to hide the target object, a method of placing superimposition information at a position that is close to but does not overlap the target object, and that is determined in each image frame, may be employed. By means of this method, superimposed information can be displayed such that the viewer can easily understand the content of the superimposed information.

However, since this method does not take into account the consistency of the position of superimposed information over time, the position of superimposed information may vary significantly in each image frame, and the viewer may not be able to understand the content of the information that is displayed.

The herein-contained embodiments are therefore configured such that the conditions: (i) superimposed information does not occlude the target object; (ii) proximity to the target object is maintained; and (iii) the consistency of the position of superimposed information is maintained over time, are all satisfied at the same time. As a result of this, superimposed information can be displayed such that the position of the superimposed information does not vary significantly in each image frame, and the viewer can easily understand the content of the superimposed information.

### Overall Example Structure of the Device

In the following description, examples of recognizing a player in the rugby video shown in FIG. 1 and indicating the player’s information will be described. However, the use of a rugby video as a processing target is just an example, and the technique according to the present invention can also be applied to player recognition in sports other than rugby, and can furthermore be used to recognize specific objects other than players, such as products, animals, buildings, signs, and so forth.

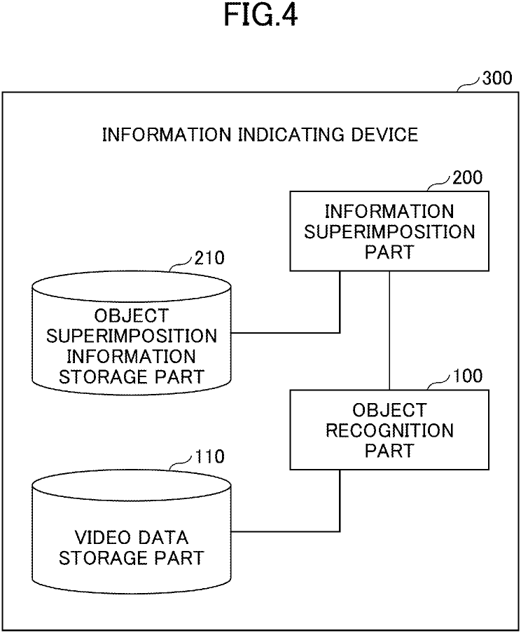

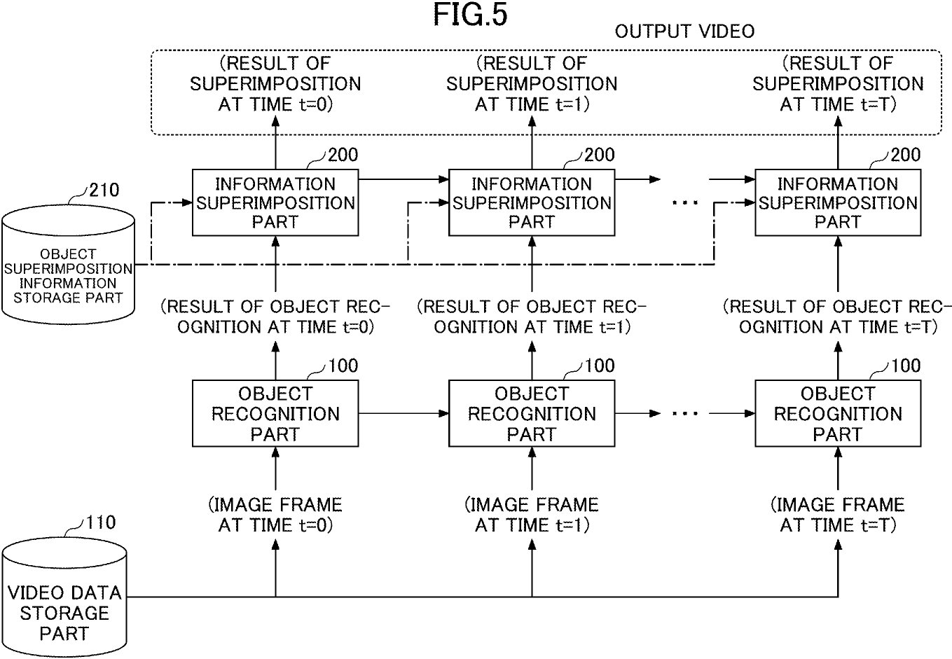

FIG. 4 shows an overall structure of an information indicating device 300 according to the embodiments. As shown in FIG. 4, the information indicating device 300 has an object recognition part 100, a video data storage part 110, an information superimposition part 200, and an object superimposition information storage part 210. Note that the video data storage part 110 may be included in the object recognition part 100, and the object superimposition information storage part 210 may be included in the information superimposition part 200. Also, the video data storage part 110 and the object superimposition information storage part 210 may be provided outside the information indicating device 300.

The information indicating device 300 may be configured by one computer, or may be configured by connecting a plurality of computers via a network. Also, the object recognition part 100 and the information superimposition part 200 may be referred to as “an object recognition device 100” and “an information superimposition device 200,” respectively. In embodiments 1 and 2 described below, these will be referred to as an “object recognition device 100” and an “information superimposition device 200,” respectively. Also, the information indicating device 300 may be referred to as an “object recognition device” or an “information superimposition device.”

The video data storage part 110 stores chronological image frames, and the object recognition part 100 and the information superimposition part 200 process each image frame as read from the video data storage part 110. FIG. 5 shows an image of how image frames of respective times are processed. As shown in FIG. 5, image frames of respective times are processed in order, from the image frame of time t=0. An overview of the operations of the object recognition part 100 and the information superimposition part 200 will follow. Details of these will be described in embodiments 1 and 2 later.

The object recognition part 100 receives as input the image frame pertaining to each time constituting the video data and stored in the video data storage part 110 and the object recognition result at the immediately preceding time, and outputs the object recognition result at the present time. Note that the “present time” is the time of the latest image that is subject to the object recognition or information superimposition process.

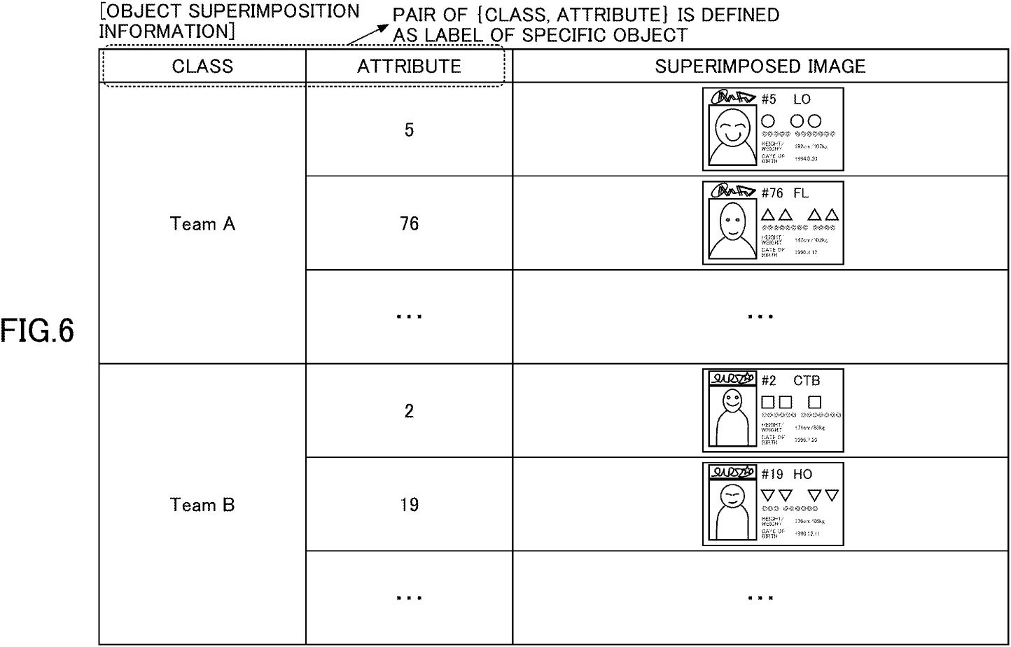

The object superimposition information storage part 210 stores the information to be superimposed for each target specific object. Examples of information to be superimposed according to the embodiments are shown in FIG. 6. The superimposition information in the example shown in FIG. 6 is data that is superimposed (superimposed image) to show a pair of each player’s class and attribute. According to the present embodiment, the class is the name of the team the player belongs to, and the attribute is the player’s uniform number. Also, in the following description, the pair of the class and the attribute will be referred to as the “label” of each specific object. According to the present embodiment, as shown in FIG. 6, the label of a specific object is uniquely determined by the combination of the object’s class and attribute.

Note that, although the “class” and “attribute” are used with the present embodiment, both are examples of attributes. Also, the “label” is also an example of an attribute. For example, the team name may be referred as an “attribute 1,” and the uniform number may be referred to as an “attribute 2.” Also, when the class is an example of an attribute, the number of attributes is not limited to two, and may be one or three or more.

Where object superimposition information is stored in the object superimposition information storage part 210, the information superimposition part 200 determines the superimposition position for superimposition information for an object captured in the image frame at the present time, based on the superimposition position in the image frame immediately before the present time, and superimposes the information over the image frame at the present time and outputs the result. The image frame of each time, over which the superimposition information is superimposed, is transmitted to, for example, a user terminal, and displayed as a video in which the superimposition information is superimposed, on the user terminal.

Hereinafter, a detailed example of the object recognition device 100 corresponding to the object recognition part 100 will be described as an embodiment 1, and a detailed example of the information superimposition device 200 corresponding to the information superimposition part 200 will be described as an embodiment 2.

### Embodiment 1

### Structure of Object Recognition Device 100

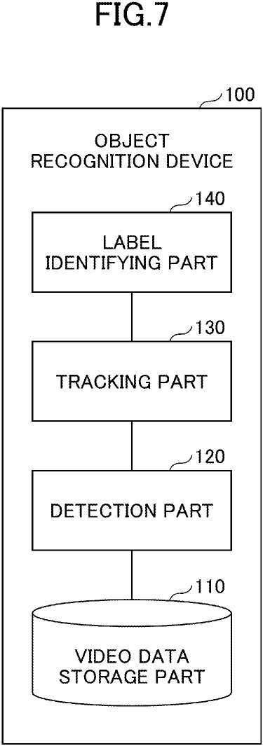

FIG. 7 shows an example structure of the object recognition device 100. As shown in FIG. 7, the object recognition device 100 includes a video data storage part 110, a detection part 120, a tracking part 130, and a label identifying part 140. The operation of each part will be summarized below.

The video data storage part 110 stores chronological image frames. The detection part 120 receives the image frame of each time constituting the video data stored in the video data storage part 110, and detects the objects captured in it.

The tracking part 130 receives as input the detection result output by the detection part 120 and a past tracking result, and outputs the tracking result at the present time. The label identifying part 140 receives as input the tracking result output from the tracking part 130 and the image frame at the present time, and determines a specific object label with respect to each tracking object.

Here, the tracking result output by the tracking part 130 consists of a set of positions of objects captured in the image frame at the present time, and a set of IDs (tracking ID set), each shared by the same individual throughout the video.

In the label identifying part 140, the label identification process is performed only for those tracking IDs that are included in the tracking result of the image frame of the present time and that have not been assigned specific object labels in the past. By this means, the number of times to identify labels can be reduced compared to the case in which label identification is performed for all the objects detected in image frames, and, as a result of this, the overall throughput of the process can be improved.

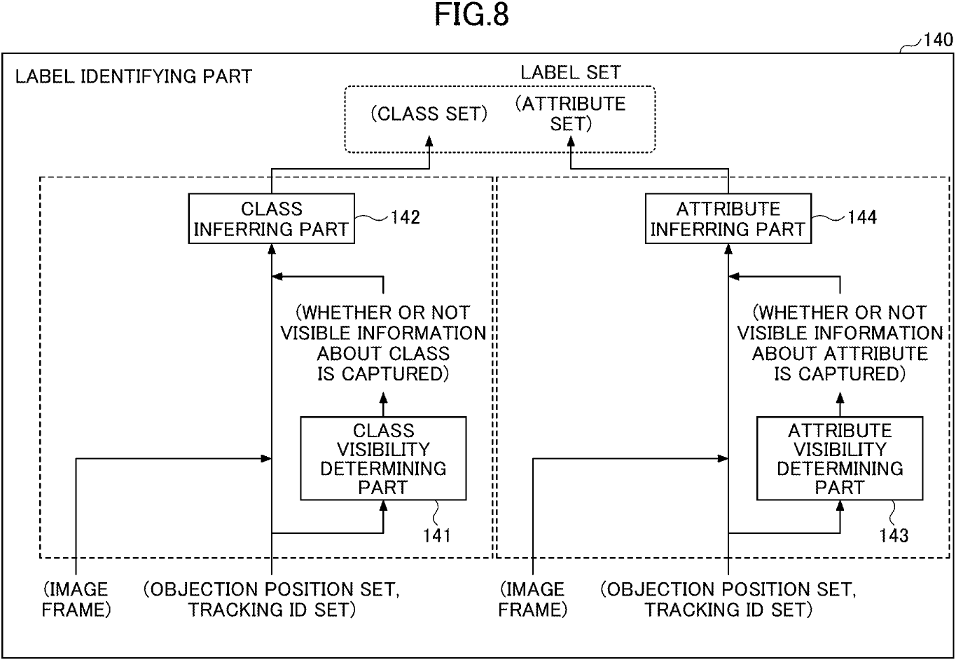

FIG. 8 shows an example structure of the label identifying part 140. As shown in FIG. 8, the label identifying part 140 has a class visibility determining part 141, a class inferring part 142, an attribute visibility determining part 143, and an attribute determining part 144. The operation of each part will be summarized below.

The class visibility determining part 141 receives the object position set and the tracking ID set as input, and determines, for each object with a tracking ID which is captured in the image frame at the present time, and to which no specific object label is assigned yet, whether or not visible information about the class is captured.

For each object with a tracking ID, with respect to which the class visibility determining part 141 determines that visible information about the class is captured, the class inferring part 142 infers the class based on the visible information.

For a given object, the class visibility determining part 141 determines whether or not visible information related to the class is captured by evaluating the object’s overlap with other objects in space in the same image frame. By inferring the class of an object for which it is determined that visible information about the class is captured in the image frame, it is possible to prevent inferring the wrong class.

The attribute visibility determining part 143 receives the object position set and the tracking ID set as input, and determines, for each object with a tracking ID which is captured in the image frame at the present time, and to which no specific object label is assigned yet, whether or not visible information about the attribute is captured.

For each object with a tracking ID, with respect to which the attribute visibility determining part 143 determines that visible information about the attribute is captured, the attribute inferring part 144 infers the attribute based on the visible information.

For a given object, the attribute visibility determining part 143 determines whether or not visible information related to the attribute is captured by evaluating the object’s overlap with other objects in space in the same image frame. By inferring the attribute of an object for which it is determined that visible information about the attribute is captured in the image frame, it is possible to prevent inferring the wrong attribute.

Note that the label identifying part 140, “the class visibility determining part 141 + the class inferring part 142,” and “the attribute visibility determining part 143 + the attribute inferring part 144” are all examples of the attribute determining part.

### Details of the Operation of the Object Recognition Device 100

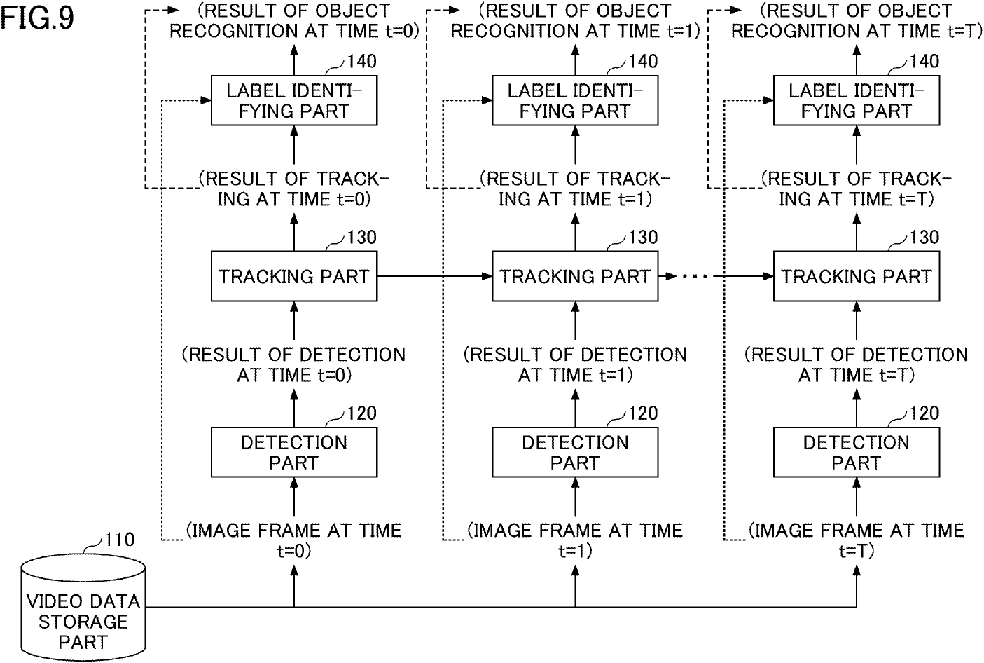

As described above, the video data storage part 110 of the object recognition device 100 stores chronological image frames, and the detection part 120 (and the tracking part 130 and the label identifying part 140) processes each image frame read from the video data storage part 110. FIG. 9 shows an image of how image frames of respective times are processed. As shown in FIG. 9, the image frames corresponding to respective times are processed in order, from the image frame of time t=0. Details of the operation of each part of the object recognition device 100 will be described below with reference to FIG. 8 to FIG. 12.

### Detection Part 120

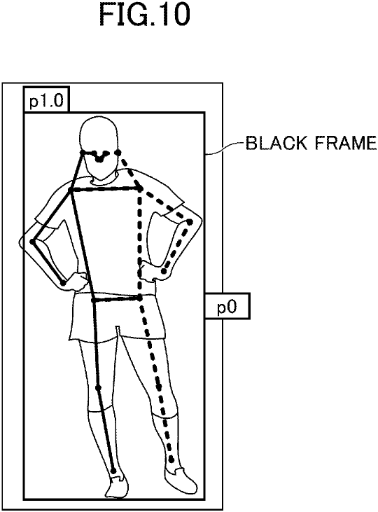

The detection part 120 receives an image frame corresponding to a given time in the video as input, detects the position of an object in it, and infers its posture. Any method can be used to determine the position of the object. For example, the position of the object can be determined by using a rectangle that encloses the object like the one defined by the black frame in FIG. 10.

Also, the method of determining the posture of the object may be any suitable method as desired. For example, as shown in FIG. 10, a set of joint points of the object (eyes, shoulders, hips, etc.: total 17 joints in this example) may be defined as a set of positions.

As in this embodiment 1, when the object to be detected is a person, any method can be used to detect the person and infer his/her posture. For example, the technique disclosed in cited reference 1 can be used. At this time, it is also possible to prepare a mask that defines the target region in the image, and determine whether or not the detected person is included in the target region, and output the filtering result.

With this embodiment 1, a mask that defines a region in the rugby court in the input image may be used, so that it is possible to exclude detection results pertaining to people such as the audience and support staff. Also, the object’s posture may be inferred after the image data is internally resized to a predetermined size.

### Tracking Part 130

The tracking part 130 receives as input the object detection result at the present time output from the detection part 120 and the past tracking result, and outputs the tracking result at the present time. Here, the tracking result is composed of a set of tracking IDs, assigned to tracking-target individuals on a respective basis, and a set of the positions (including postures) of the individuals of respective tracking IDs at the present time. The tracking part 130 may perform the above-described tracking, for example, by using the techniques disclosed in cited reference 4.

### Label Identifying Part 140

In the tracking result of the present time output from the tracking part 130, the label identifying part 140 assigns a label to an individual with an ID that has not been assigned a label. As mentioned above, the label in this embodiment 1 is defined by a combination of a class and an attribute.

As shown in FIG. 8, the label identifying part 140 is composed of a class visibility determining part 141, a class inferring part 142, an attribute visibility determining part 143, and an attribute inferring part 144. The operation of each part will be described below.

### Class Visibility Determining Part 141

The class visibility determining part 141 receives the set of object positions at the present time as input, determines, for each object, whether or not the object is visible enough to recognize its class, and outputs the result.

To determine whether an object is visible enough to recognize its class, the class visibility determining part 141 according to this embodiment 1 calculates to what extent the object is not hidden by objects located in front of the object, and compares this value with a predetermined threshold.

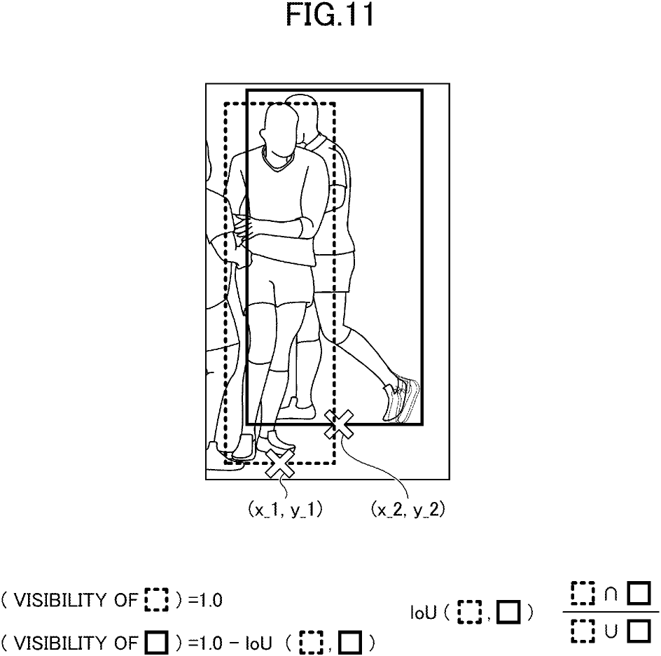

The method of extracting objects located in front of an object of interest is not limited to a specific method, and any method can be used. An example method of extracting objects located in front of an object of interest will be described with reference to FIG. 11.

FIG. 11 shows an example in which a target object (person) is present on a flat stadium. In this case, the y-coordinates of positions corresponding to individual objects’ feet on the image may be compared. In the example of FIG. 11, since y_2 is larger than y_1, it is possible to determine that the person corresponding to y_1 is located in front of the person corresponding to y_2.

Also, the calculation of the extent to which an object of interest is not hidden is not limited to a specific method, and any method can be used. For example, the intersection-over-union (IoU) may be calculated between the object of interest and each object that is located in front of the object of interest, and the maximum value may be subtracted from 1 to determine the extent to which the object of interest is not hidden (that is, how visible it is). This indicator indicates visibility.

For example, in the example of FIG. 11, the visibility of the person in front is V1, and the visibility of the person in the back is V2. Since the person in front is not hidden, V1=1. Also, if (the intersection of the “the area of the person in front” and “the area of the person in the back”) ÷ (the union of “the area of the person in front” and “the area of the person in the back”), that is, IoU, is 0.4, then V2=1-0.4=0.6.

For example, if V2 is greater than the threshold with respect to the person in the back, the class visibility determining part 141 determines that the person in the back is visible enough to recognize the person’s class.

### Class Inferring Part 142

In the tracking result at the present time, if there is an object that is not assigned a class and that is determined by the class visibility determining part 141 to be visible enough to recognize its class, the class inferring part 142 infers and outputs the class of the object. The method of inferring the class is not limited to a specific method, and any method can be used.

For example, the technique disclosed in cited reference 5 may be used to extract a feature from a partial region in an image frame corresponding to an object’s position, input the feature into an identifier such as a support vector machine (SVM), and classify the object in the partial region into a predetermined class. Alternatively, for example, typical features may be defined in advance for each class, and then a feature extracted from a partial region may be compared with these typical features, and the class corresponding to the most similar value may be assigned. Any method may be used to calculate the typical features, and, for example, features extracted from objects of each class may be averaged.

### Attribute Visibility Determining Part 143

The attribute visibility determining part 143 receives the set of object positions at the present time as input, determines, for each object, whether or not the object is visible enough to recognize its attribute, and outputs the result. With this embodiment 1, posture information of each object is used to determine whether or not each object is visible enough to recognize its attribute.

In this embodiment 1, a uniform number is printed on the back of a player, that is, the target object. Given this condition, an example method of determining whether or not an object is visible enough to recognize its attribute will be described with reference to FIG. 12.

In the example of FIG. 12, the posture of a person is represented by the positions of the person’s joint points (shoulders, waist, etc.) on the image. To be more specific, in the case of FIG. 12, the attribute visibility determining part 143 acquires a left shoulder position pₗₛ= (xₗₛ, yₗₛ), a right shoulder position pᵣₛ=(xᵣₛ, yᵣₛ), a left waist position p_{lw}=(x_{lw,} y_{lw}), and a right waist position p_{rw}= (x_{rw}, y_{rw}).

The attribute visibility determining part 143 determines whether the following equation is satisfied.

$${x}_{r s} > {x}_{l s} \text{and} {x}_{r w} > {x}_{l w} \text{and} \frac{1}{{σ}_{\text{aspect}}} > \frac{\left(\overline{{P}_{l s} {P}_{r s}} + \overline{{P}_{l w} {P}_{r w}}\right)}{\left(\overline{{P}_{l s} {P}_{l w}} + \overline{{P}_{r s} {P}_{r w}}\right)} > {σ}_{\text{aspect}}$$

In the above formula, the bar above pₗₛpᵣₛ indicates the length between pₗₛ and pᵣₛ. Also, σ_{aspect} is a parameter. Note that 1>σ_{aspect}>0. When the attribute visibility determining part 143 detects that the above formula is satisfied, the attribute visibility determining part 143 determines “True” (that is, the region where the attribute is included is visible) with respect to the person. If the attribute visibility determining part 143 detects that the above formula is not satisfied, the attribute visibility determining part 143 determines “False” (that is, the region where the attribute is included is not visible).

In addition to the method of using the posture of the object or instead of the method of using the posture of the object, the attribute visibility determining part 143 may determine whether or not the target object is visible enough to recognize its attribute based on the overlap between objects, in the same way as the class visibility determining part 141 does.

Note that, in addition to the method of using the overlap between objects or instead of the method of using the overlap between objects, the class visibility determining part 141 may use a method of using the posture of the object to determine whether or not its class is recognizable, in the same way as the attribute visibility determining part 143 does.

### Attribute Determining Part 144

In the tracking result at the present time, if there is an object that is not assigned an attribute and that is determined by the attribute visibility determining part 143 to be visible enough to recognize its attribute, the attribute determining part 144 infers and outputs the attribute of the object. The method of inferring the attribute is not limited to a specific method, and any method can be used.

### Effect of Embodiment 1

According to this embodiment 1, it is possible to recognize a specific object at high speed, with high accuracy.

### Embodiment 2

Next, embodiment 2 will be explained. With embodiment 2, an information superimposition device 200, which corresponds to the information superimposition part 200 in the information indicating device 300 of FIG. 4, will be described in detail.

### Structure of Information Superimposition Device 200

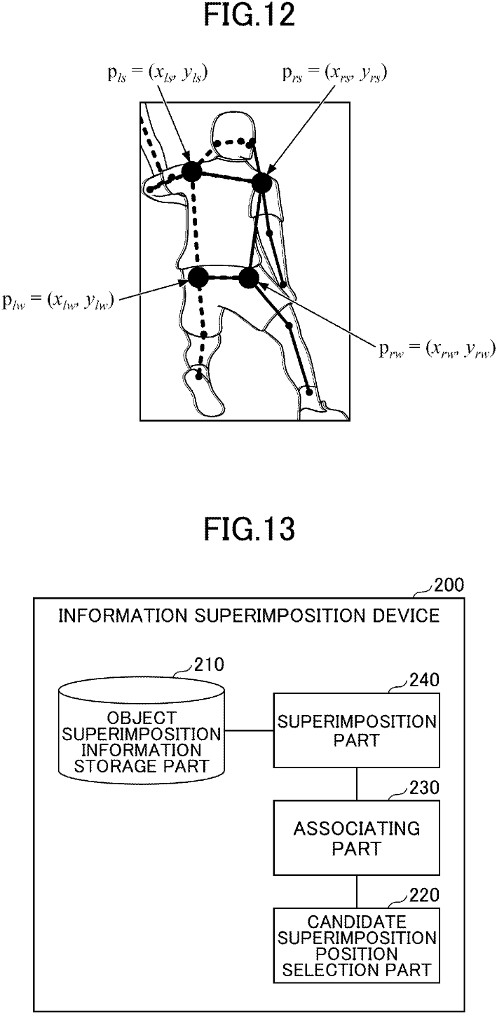

FIG. 13 shows an example structure of the information superimposition device 200. As shown in FIG. 13, the information superimposition device 200 includes an object superimposition information storage part 210, a candidate superimposition position selection part 220, an associating part 230, and a superimposition part 240. Note that, with the present embodiment, the information superimposition device 200 receives the object recognition result by the object recognition device 100 as input, for each image frame processed by the object recognition device 100 of embodiment 1, and performs the process. Also, these image frames are also input to the information superimposition device 200.

However, this is only an example, and the information superimposition device 200 may operate by using an object recognition result obtained by any method as input, without presuming the use of the object recognition device 100 of embodiment 1. The operation of each part of the information superimposition device 200 will follow.

The object superimposition information storage part 210 stores superimposition information as shown in FIG. 6, for example. The candidate superimposition position selection part 220 receives the object recognition result output from the object recognition device 100 as input, selects candidate positions (candidate superimposition positions) for superimposing and displaying object information, and outputs the selected candidate superimposition positions.

Using the object recognition result, the candidate superimposition positions, and the object/superimposition position association result in the previous image frame as input, the associating part 230 associates the objects in the image frame at the present time with superimposition positions. Based on the result of associating objects with superimposition positions by the associating part 230, the superimposition part 240 superimposes the object superimposition information over the image frame at the present time, and outputs the resulting image frame. Image frames in which object superimposition information is superimposed are thus output sequentially, so that, for example, a video in which information related to objects is superimposed is displayed on a user terminal.

Here, the candidate superimposition position selection part 220 outputs candidate superimposition positions that do not overlap the object positions recognized in the image frame of the present time. This makes it possible to satisfy the condition (i) “superimposed information does not occlude the target object.” Also, through optimization of an objective function that satisfies the condition that superimposed information is displayed near each object recognized in the image frame at the present time, and the condition that each superimposed information displayed in the previous image frame does not change its position significantly in the present frame, the associating part 230 determines the superimposition information display position for each object, from the candidate superimposition positions. As a result of this, the above-mentioned conditions (ii) “proximity to the target object is maintained” and (iii) “the consistency of the position of superimposed information is maintained over time” can be satisfied.

### Details of the Operation of the Information Superimposition Device 200

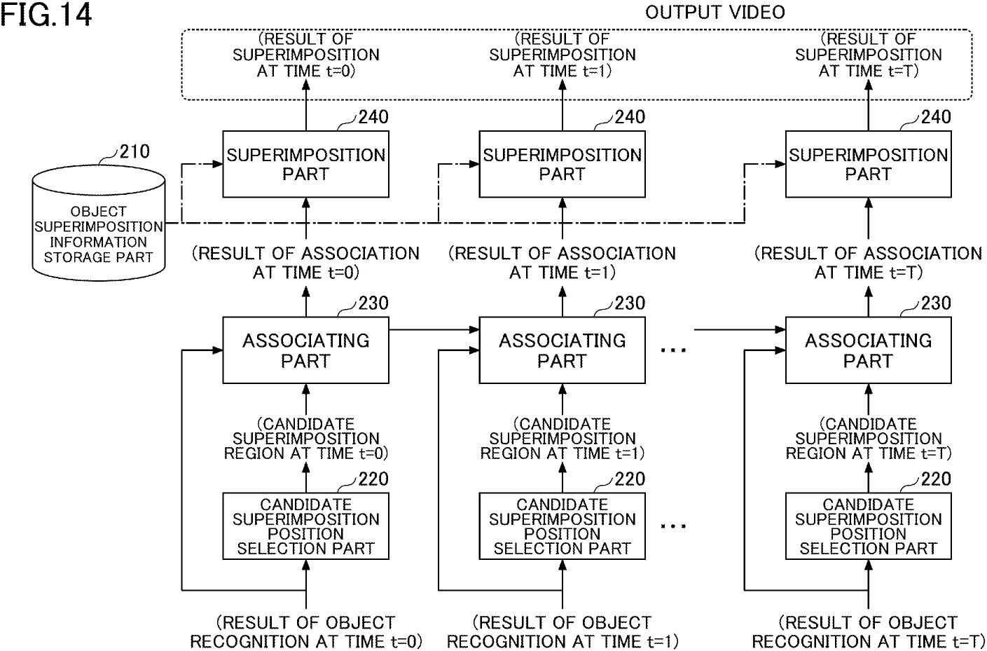

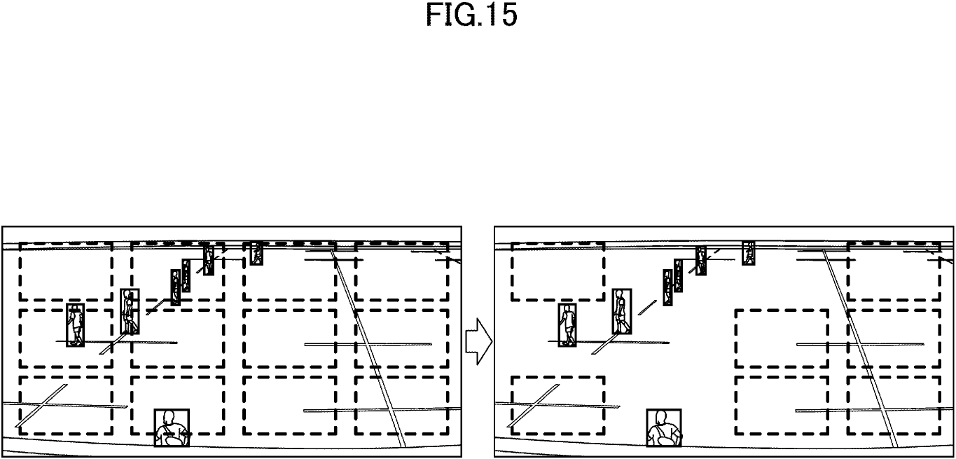

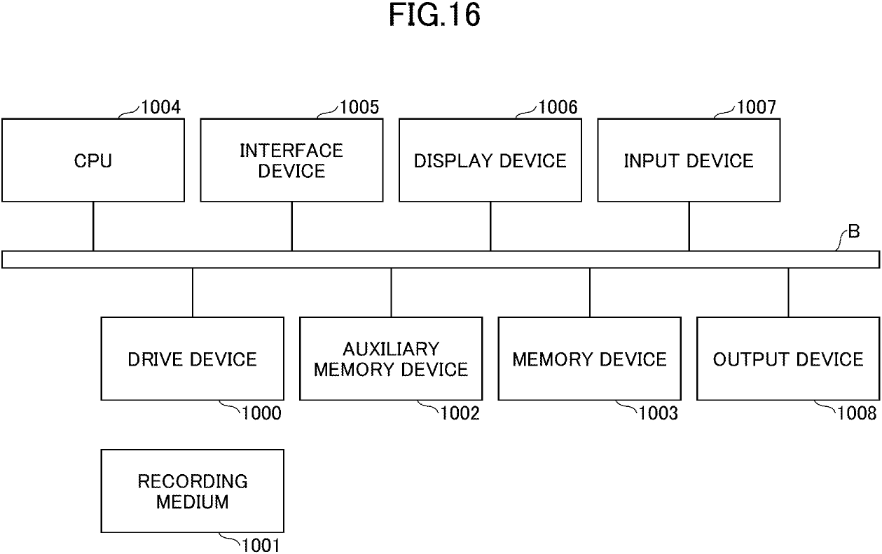

As described above, for each image frame processed by the object recognition device 100, the information superimposition device 200 receives the processing result, namely the object recognition result, as input. FIG. 14 shows a diagram of processing the object recognition result of each time. As shown in FIG. 14, starting from the object recognition result obtained from the image frame at time t=0, the object recognition results of respective times are processed in order. Details of the operation of each part of the information superimposition device 200 will be described below with reference to FIG. 14 and FIG. 15.

### Candidate Superimposition Position Selection Part 220

Using the object recognition result at each time as an input, the candidate superimposition position selection part 220 selects and outputs candidate object superimposition positions, which serve as candidate positions that do not overlap the recognized objects, and in which object superimposition information can be superimposed.

As for the method of outputting candidate object superimposition positions, for example, as shown in FIG. 15, calculation may be carried out for all overlaps between the superimposition positions provided in a grid shape (the dotted-line frames in the left part of FIG. 15) and the object positions (solid-line frames), and the superimposition positions that do not overlap any of the objects (the dotted-line frames in the right part of FIG. 15) may be extracted and output.

Also, as for the method of calculating the overlaps in the above process, for example, intersection-over-union (IoU) may be used. That is, by using IoU, for example, regions corresponding to the superimposition positions where IoU=0 (the dotted-line frames in the right part of FIG. 15) may be extracted.

Note that, although the above example (the example shown in the right part of FIG. 15) allows no overlaps at all between the candidate superimposition positions and the object positions, it is equally possible to provide a predetermined parameter, allow those overlaps that do not exceed that value, and select the candidate superimposition positions accordingly.

### Associating Part 230

The associating part 230 associates between the candidate superimposition positions output by the candidate superimposition position selection part 220 and the objects recognized at the present time, and determines the information superimposition position for each object.

To be more specific, the associating part 230 determines these associations such that the condition that superimposition information is displayed near each object recognized in the image frame at the present time, and the condition that each superimposition information displayed in the previous image frame does not change its position significantly in the image frame at the present time, are both satisfied at the same time. An example of how to perform the above associations will be described below.

{ (l₁, b₁), ..., (lᵢ, bᵢ), ..., (l_{Nt}, b_{Nt}) } is a set of specific objects detected from a frame Iₜ of a time t by the object recognition device 100. l_{i∈}Lₜ is the label of a specific object, and bᵢ is the detection result. bᵢ is a vector defined by, for example, information of the four corners of a rectangle. Also, {c₁, ..., cⱼ, ..., c_{M})} is a set of candidate superimposition positions at present time t. For example, when the superimposition information is an image, cⱼ is information (vector) of the four corners of a rectangle. Furthermore, the positions where each object’s label information lᵢ∈Lₜ₋₁ is superimposed at time t-1, which is immediately before present time t, is {p₁, ..., pᵢ, ... }.

Letting {aᵢⱼ}∈R^{N×M} be a value indicating the appropriateness of associating an object i with a candidate superimposition position j, the value may be defined as in following equation 1, and the associating part 230 may calculate each aᵢⱼ.

$${a}_{i j} = \left\{\begin{matrix}\text{dist} \left({\text{p}}_{i}^{t - 1} , {\text{c}}_{j}\right) & \text{if} {l}_{i} ∈ {L}_{t - 1} , \\ \text{dist} \left({\text{b}}_{i} , {\text{c}}_{j}\right) & \text{otherwise} \text{.}\end{matrix}\right)$$

dist (m, n) in above equation 1 is a function that outputs the distance between positions m and n, and, for example, may be defined as a function for calculating the L2 norm of the central coordinates of m and n. Equation 1 means that, when the information of label lᵢ of a specific object is superimposed at time t-1, the distance between that position p^{t-1}ᵢ and candidate superimposition position cⱼ at time t becomes aᵢⱼ, and that, when the information of label lᵢ of the specific object is not superimposed at time t-1, the distance between the specific object’s position bᵢ and candidate superimposition position cⱼ becomes aᵢⱼ.

When the label lᵢ of a specific object is superimposed at time t-1, making distance aᵢⱼ between that position p^{t-1}ᵢ and candidate superimposition position cⱼ small means that each superimposed information displayed in the previous image frame does not change its position significantly in the present frame. Also, making distance aᵢⱼ between position bᵢ of a specific object and candidate superimposition position cⱼ small means displaying superimposition information near each object recognized in the image frame at the present time.

Note that, with this embodiment, when the information of label lᵢ of a specific object is superimposed at time t-1, distance aᵢⱼ between its position p^{t-1}ᵢ and candidate superimposition position cⱼ is made small (referred to as “A”), and, when the information of label lᵢ of the specific object is not superimposed at time t-1, distance aᵢⱼ between position bᵢ of the specific object and candidate superimposition position cⱼ is made small (referred to as “B”). That is, although, with this embodiment, an objective function is defined and the optimization problem of following equation 2 is solved by using both of above methods A and B, it is equally possible to solve the optimization problem of following equation 2 by using only one of above methods A and B.

Defining {xᵢⱼ}∈R^{N×M} as a binary matrix that takes the value of 1 when object i is associated with candidate superimposition position j and takes the value of 0 otherwise, the associating part 230 may determine a {xᵢⱼ} that satisfies following equation 2, and thereby the associating part 230 can obtain an association {xᵢⱼ}* that satisfies both conditions that superimposed information is displayed near each object recognized in the image frame at the present time, and that each superimposed information displayed in the previous image frame does not change its position significantly in the present frame, at the same time.

$$\left\{{x}_{i j}\right\} * = {\text{arg min}}_{\left\{{x}_{i j}\right\}} {\sum }_{i}^{N} {\sum }_{j}^{M} {a}_{i j} {x}_{i j} \text{s} \text{.t} ∀ i , {\sum }_{j}^{M} {x}_{i j} = 1 \text{and} ∀ j , {\sum }_{i}^{N} {x}_{i j} \leq 1$$

Above equation 2 means finding {xᵢⱼ} that minimizes the total sum of aᵢⱼ×ᵢⱼ under restrictions that one object be associated with one candidate superimposition position, and that one candidate superimposition position be associated with maximum one object. Equation 2 can be solved by using any algorithm, and, for example, the Hungarian algorithm may be used.

Note that, although the above example is configured to select an association that satisfies both conditions that superimposition information be displayed near each object recognized in the image frame at the present time, and that each superimposed information displayed in the previous image frame does not change its position significantly in the present frame, at the same time, this is just an example. It is equally possible to select an association that satisfies only the condition that superimposed information be displayed near each object recognized in the image frame at the present time, or select an association that satisfies only the condition that each superimposed information displayed in the previous image frame not change its position significantly in the present frame.

### Superimposition Part 240

The superimposition part 240 superimposes the object superimposition information over the image frame at the present time, based on the results of associating between objects and superimposition positions, obtained by the associating part 230.

### Effect of Embodiment 2

As explained above, according to this embodiment 2, superimposed information can be displayed such that the viewer can easily understand the content of the superimposed information. To be more specific, for example, it is possible to superimpose information over a video such that the conditions: (i) the superimposed information does not occlude the target object; (ii) proximity to the target object is maintained; and (iii) the consistency of the position of the superimposed information is maintained over time, are all satisfied at the same time. Note that it is not essential to satisfy all these three conditions at the same time. If at least one of these conditions is satisfied, superimposed information can be displayed such that the viewer can easily understand the content of the superimposed information. Nevertheless, by satisfying the above three conditions at the same time, the effect of displaying superimposed information in such a way that the content of the superimposed information can be easily understood may be maximized.

### Example of Hardware Structure

All of the object recognition device 100, the information superimposition device 200, and the information indicating device 300 can be implemented, for example, by causing a computer to execute programs. This computer may be a physical computer or a virtual machine on a cloud. Note that, hereinafter, the object recognition device 100, the information superimposition device 200, and the information indicating device 300 will be collectively referred to as “devices.”

That is, the devices can be realized by executing programs corresponding to the processes performed by the devices by using hardware resources such as a central processing unit (CPU) and a memory built in a computer. The above programs can be recorded in a computer-readable recording medium (portable memory, etc.) and saved or distributed. Also, it is possible to provide the above programs through a network such as the Internet or by using e-mail.

FIG. 16 is a diagram that shows an example hardware structure of the computer. The computer of FIG. 16 includes a drive device 1000, an auxiliary memory device 1002, a memory device 1003, a CPU 1004, an interface device 1005, a display device 1006, an input device 1007, an output device 1008 and the like, which are inter-connected via a bus B. Note that, some of these may not be provided. For example, when not displaying anything, the display device 1006 may not be provided.

The programs for realizing the processes in the computer are provided by means of a recording medium 1001 such as a compact disc read-only memory (CD-ROM) or a memory card, for example. When the recording medium 1001 storing the programs is placed in the drive device 1000, the programs are installed from the recording medium 1001 to the auxiliary memory device 1002 via the drive device 1000. However, the programs do not necessarily have to be installed from the recording medium 1001, and may be downloaded from another computer via a network. The auxiliary memory device 1002 stores the installed programs, and also stores the necessary files and data.

When there is an instruction to start a program, the memory device 1003 reads out the program from the auxiliary memory device 1002 and stores it. The CPU 1004 implements the functions related to the devices according to the program stored in the memory device 1003. The interface device 1005 is used as an interface for connecting with a network, and functions as a transmitting part and a receiving part. The display device 1006 displays a GUI (Graphical User Interface) or the like by the program. The input device 1007 is composed of a keyboard, a mouse, buttons, a touch panel, or the like, and is used to input various operational instructions. The output device 1008 outputs the calculation result.

### Summary of Embodiment 1

This specification discloses at least the following object recognition device, object recognition method, and program.

### Number 1

An object recognition device having:
a memory; and
a processor coupled to the memory and configured to:
   track one or more objects that are detected from a video; and
   determine whether or not an attribute of an undetermined object can be determined, based on appearance information of the undetermined object in the video, the undetermined object being an object whose attribute is not yet determined among the one or more objects that are tracked, and determine the attribute of the undetermined object when the attribute of the undetermined object can be determined.

### Number 2

The object recognition device according to number 1, in which the processor is further configured to determine whether or not the attribute of the undetermined object can be determined by calculating an index value that indicates an extent to which the undetermined object is not hidden by other objects, and by comparing the index value with a threshold.

### Number 3

The object recognition device according to number 1, in which the processor is further configured to determine whether or not the attribute of the undetermined object can be determined by determining whether or not a predetermined region of the undetermined object is visible, based on information about a posture of the undetermined object.

### Number 4

An object recognition method, including:
tracking one or more objects that are detected from a video; and
determining whether or not an attribute of an undetermined object can be determined, based on appearance information of the undetermined object in the video, the undetermined object being an object whose attribute is not yet determined among the one or more objects that are tracked, and determining the attribute of the undetermined object when the attribute of the undetermined object can be determined.

### Number 5

A program for causing a computer to function as the object recognition device according to number 1.

### Number 6

A non-transitory recording medium storing a program for causing a computer to:
track one or more objects that are detected from a video; and
determine whether or not an attribute of an undetermined object can be determined, based on appearance information of the undetermined object in the video, the undetermined object being an object whose attribute is not yet determined among the one or more objects that are tracked, and determine the attribute of the undetermined object when the attribute of the undetermined object can be determined.

### Summary of Embodiment 2

This specification discloses at least the following information superimposition device, information superimposition method, and program.

### Number 1

An information superimposition device for superimposing, in a video, superimposition information that is associated with an object in the video, the information superimposition device including:
a memory; and
a processor coupled to the memory and configured to:
   extract candidate superimposition positions from the video, based on positions of one or more objects recognized in the video, the candidate superimposition positions being positions where the superimposition information can be superimposed without overlapping the one or more objects recognized in the video; and
   determine a position of the superimposition information, based on a set of the candidate superimposition positions and the positions of the one or more objects recognized in the video, such that a distance between the object and the superimposition information that is associated with the object is made small.

### Number 2

An information superimposition device for superimposing, in a video, superimposition information that is associated with an object in the video, the information superimposition device including:
a memory; and
a processor coupled to the memory and configured to:
   extract candidate superimposition positions from the video, based on positions of one or more objects recognized in the video, the candidate superimposition positions being positions where the superimposition information can be superimposed without overlapping the one or more objects recognized in the video; and
   determine a position of the superimposition information, based on a set of the candidate superimposition positions and the positions of the one or more objects recognized in the video, such that the position of the superimposition information changes little between image frames.

### Number 3

The information superimposition device according to number 1, in which the processor is further configured to determine the position of the superimposition information, based on the set of the candidate superimposition positions and the positions of the one or more objects recognized in the video, such that the distance between the object and the superimposition information that is associated with the object is made small, and such that the position of the superimposition information changes little between image frames.

### Number 4

The information superimposition device according to number 3, in which the processor is configured to determine the position of the superimposition information for each object by solving an optimization problem in which an objective function is designed such that:
when the superimposition information is superimposed with respect to an object at a previous time, a distance between the superimposition information at the previous time and a candidate superimposition position is made small; and
when the superimposition information is not superimposed with respect to the object at the previous time, a distance between the object and the candidate superimposition position is made small.

### Number 5

An information superimposition method to be executed by an information superimposition device for superimposing, in a video, superimposition information that is associated with an object in the video, the information superimposition method including:
extracting candidate superimposition positions from the video, based on positions of one or more objects recognized in the video, the candidate superimposition positions being positions where the superimposition information can be superimposed without overlapping the one or more objects recognized in the video; and
determining a position of the superimposition information, based on a set of the candidate superimposition positions and the positions of the one or more objects recognized in the video, such that a distance between the object and the superimposition information that is associated with the object is made small, and such that the position of the superimposition information changes little between image frames.

### Number 6

A program for causing a computer to function as the information superimposition device according to number 1.

### Number 7

A non-transitory recording medium storing a program for causing a computer to:
extract candidate superimposition positions from the video, based on positions of one or more objects recognized in the video, the candidate superimposition positions being positions where the superimposition information can be superimposed without overlapping the one or more objects recognized in the video; and
determine a position of the superimposition information, based on a set of the candidate superimposition positions and the positions of the one or more objects recognized in the video, such that a distance between the object and the superimposition information that is associated with the object is made small.

### Number 8

A non-transitory recording medium storing a program for causing a computer to:
extract candidate superimposition positions from the video, based on positions of one or more objects recognized in the video, the candidate superimposition positions being positions where the superimposition information can be superimposed without overlapping the one or more objects recognized in the video; and
determine a position of the superimposition information, based on a set of the candidate superimposition positions and the positions of the one or more objects recognized in the video, such that the position of the superimposition information changes little between image frames.

### Number 9

A non-transitory recording medium storing a program for causing a computer to:
extract candidate superimposition positions from a video, based on positions of one or more objects recognized in the video, the candidate superimposition positions being positions where superimposition information can be superimposed without overlapping the one or more objects recognized in the video; and
determine the position of the superimposition information, based on the set of the candidate superimposition positions and the positions of the one or more objects recognized in the video, such that the distance between the object and the superimposition information that is associated with the object is made small, and such that the position of the superimposition information changes little between image frames.

Although embodiments of the present invention have been described above, the present invention is by no means limited to these specific embodiments, and various modifications and changes may be made within the scope of the present invention recited in the accompanying claims.

### CITED REFERENCES

[1] X. Zhou, D. Wang, and P. Krähenbühl. Objects as points. In arXiv preprint arXiv: 1904.07850, 2019.

G. Li, S. Xu, X. Liu, L. Li, and C. Wang. Jersey number recognition with semi-supervised spatial transformer network. In CVPR Workshop, 2018.

Y. Wu, A. Kirillov, F. Massa, W.-Y. Lo, and R. Girshick. Detectron2. https://github.com/facebookresearch/detectron2, 2019.

A. Bewley, Z. Ge, L. Ott, F. Ramos, and B. Upcroft. Simple online and realtime tracking. In ICIP, 2016.

K. Zhou, Y. Yang, A. Cavallaro, and T. Xiang. Omni-scale feature learning for person re-identification. In ICCV, 2019.

What is claimed is:

1. An information superimposition device for superimposing, in a video, superimposition information that is associated with an object in the video, the information superimposition device comprising:
a memory; and
a processor coupled to the memory and configured to:
extract candidate superimposition positions from the video, based on positions of one or more objects recognized in the video, the candidate superimposition positions being positions where the superimposition information can be superimposed without overlapping the one or more objects recognized in the video; and
determine a position of the superimposition information, based on a set of the candidate superimposition positions and the positions of the one or more objects recognized in the video, such that a distance between the object and the superimposition information that is associated with the object is made small.

2. An information superimposition device for superimposing, in a video, superimposition information that is associated with an object in the video, the information superimposition device comprising:
a memory; and
a processor coupled to the memory and configured to:
extract candidate superimposition positions from the video, based on positions of one or more objects recognized in the video, the candidate superimposition positions being positions where the superimposition information can be superimposed without overlapping the one or more objects recognized in the video; and
determine a position of the superimposition information, based on a set of the candidate superimposition positions and the positions of the one or more objects recognized in the video, such that the position of the superimposition information changes little between image frames.

3. The information superimposition device according to claim 1, wherein the processor is further configured to determine the position of the superimposition information, based on the set of the candidate superimposition positions and the positions of the one or more objects recognized in the video, such that the distance between the object and the superimposition information that is associated with the object is made small, and such that the position of the superimposition information changes little between image frames.

4. The information superimposition device according to claim 3, wherein the processor is further configured to determine the position of the superimposition information for each object by solving an optimization problem in which an objective function is designed such that:
when the superimposition information is superimposed with respect to an object at a previous time, a distance between the superimposition information at the previous time and a candidate superimposition position is made small; and
when the superimposition information is not superimposed with respect to the object at the previous time, a distance between the object and the candidate superimposition position is made small.

5. An information superimposition method to be executed by an information superimposition device for superimposing, in a video, superimposition information that is associated with an object in the video, the information superimposition method comprising:
extracting candidate superimposition positions from the video, based on positions of one or more objects recognized in the video, the candidate superimposition positions being positions where the superimposition information can be superimposed without overlapping the one or more objects recognized in the video; and
determining a position of the superimposition information, based on a set of the candidate superimposition positions and the positions of the one or more objects recognized in the video, such that a distance between the object and the superimposition information that is associated with the object is made small, and such that the position of the superimposition information changes little between image frames.

6. A non-transitory recording medium storing a program for causing a computer to function as the information superimposition device of claim 1.
